(19) United States
(12) Patent Application Publication
(10) Pub. No.: US 2019/0026812 A9
(43) Pub. Date: Jan. 24, 2019

(54) Further Improvements in Recommendation Systems

(71) Applicants: Kenneth L. Levy, Stevenson, WA (US); Neil E. Lofgren, White Salmon, WA (US)

(72) Inventors: Kenneth L. Levy, Stevenson, WA (US); Neil E. Lofgren, White Salmon, WA (US)

(73) Assignee: 4-TELL, INC, Stevenson, WA (US)

(21) Appl. No.: 13/107,858

(22) Filed: May 13, 2011

Related U.S. Application Data
(63) Continuation-in-part of application No. 12/764,091, filed on Apr. 20, 2010, now abandoned.
(60) Provisional application No. 61/334,185, filed on May 13, 2010.
(60) Provisional application No. 61/171,055, filed on Apr. 20, 2009.
(60) Provisional application No. 61/179,074, filed on May 18, 2009.
(60) Provisional application No. 61/224,914, filed on Jul. 13, 2009.
(60) Provisional application No. 61/229,617, filed on Jul. 29, 2009.
(60) Provisional application No. 61/236,882, filed on Aug. 26, 2009.

(51) Int. Cl. G06Q 30/06

(52) U.S. Cl. CPC G06Q 30/0631

(57) ABSTRACT

This invention deals with improving recommendation systems. The first embodiment combines rules and recommendations to create automated and intelligent business rules for recommendations. The second embodiment improves recommendations by combining the results of driver products and influencer products, where influencer products only influence the recommendations of the driver products. Influencer products can be related to a specific user. The third embodiment improves recommendations for new items by relating them to original items, such that the sales for the original item is used in the new item when calculating recommendations. The new items may replace the original item, or be a similar item and exist alongside the original item.

### TECHNICAL FIELD OF INVENTION

The present invention relates to recommendation systems, data mining, and knowledge discovery in databases.

### BACKGROUND OF THE INVENTION

Recommendation systems have been developed for large e-commerce websites and have been reported to account for 35% to 75% of transactions. However, these systems are customized, thus, expensive to develop and not easily adaptable to other websites, especially websites with few sales and products with 6 month lifecycles. They do not work off-the-shelf, requiring customization and difficult integration with the websites.

Recommendation systems have two parts, generator and recommendation engine. The generator creates the recommendations. It lists N, usually 20, recommended items (or users) for each target item (user). It can be manual entry, but is usually an automated system using correlation or neural networks to relate items based upon user actions. There are numerous examples in the prior art, including patent application Ser. No. 12/764,091 entitled “Improvements in Recommendations Systems” by Ken Levy and Neil Lofgren, included herein by reference.

The recommendation engine receives requests for recommendations, and returns the recommended items. The request usually includes the number of desired recommendations, as well as can include the starting position (used to randomize recommendations each call) and type of return (e.g. text with tabs, text with spaces, XML, etc.).

The problems are numerous. Many of them arise because recommendations have been created for larger retailers that have numerous actions on each product, even new products.

In addition, current systems are that the training and recommending process have always been done by the same client. The systems have also not combined preferences and actions between different clients. Nor have other systems made recommendations a game-like experience for the user. Specifically, manufacturers recommend products on their website, but would like dealers (i.e. retailers) to use the same recommendations to sell more of their products on dealers' websites. Retailers and manufacturers would like to use information in social networks to recommend items to consumers, and these consumers may have never shopped on their website. Furthermore, retailers and manufacturers are interested in attracting consumers to look at their products on mobile devices, and engaging consumers with a game-like interface.

For genomic recommendations, one category can dominate the recommendations. View data is useful for determining recommendations, but can be expensive to maintain since there is so much view data.

It is not ideal to have your complete ecommerce store on a social media commerce site. Stores do not have recommendations to help sales people and shoppers. It is desirable for a merchandiser to easily manipulate recommendations. Recommendations should be influenced by items other than what the shopper is viewing. Recommendations in email are valuable. Lowering the cost of recommendation infrastructure help solutions become available to all retailers. Interactive recommendations can help with customer engagement. It would be nice to know what friends bought, and not have long delays to learn these results. Returns can have a bad effect on recommendations.

### SUMMARY OF THE INVENTION

This patent application traverses the numerous limitations discussed in the background.

Push recommendations enable manufacturers to generate recommendations, and then a shared system to allow dealers to show recommendations of other of the manufacturer's product when a consumer is viewing or buying a specific manufacturer's product on the dealer's website. The recommendations are generated using the manufacturer's sales data, sales data from dealers, and/or manually entered recommendations or promotions. The dealer uploads their catalog of products by that manufacturer. The recommendation generator uses product names to link product IDs from dealer to manufacturer, if they don't match SKUs. The generator also creates recommendations for each product in the limited catalog.

The recommendations are limited to items carried by each dealer. The recommendation engine receives a call from the dealer, with the manufacturer's product, and returns the recommendations to the dealer that are generated by the manufacturer.

Recommendations can be generated to have only a few items from each attribute such that there is more diversity in the recommendations. This can help increase sales for a retailer since it recommends items deeper in the retailer's catalog. This limitation also provides more diversity in genomic recommendations. Specifically, the top few selling items for the most related attributes to the target item attributes are used for the recommendations.

A mobile commerce application is created that allows users to select items, and then learn what is recommended with the item. The recommendations may be across retailers or within retailers, and with specific product (i.e. universal code like ISBN, UPC, etc.) or products with the specified text in their name.

Recommendations can also be limited to preferably include less than a user specified number of items with one attribute element. The number of recommendations with an attribute element can be more than the specified number if not enough other recommendations exist. For example, the system can limit recommendations to include only two sunglasses (unless there are no other good recommendations) so the retailer can sell other items.

Social recommendations can be created by using actions for a limited group of friends, rather than the complete social network. This improves recommendations because friends provide more relevant data.

Furthermore, the friends can be limited to the friends that the user is actively involved in sharing information, as opposed to the complete friend list (a.k.a. social graph).

Results using similarity measurements as used in recommendations can be used to automate web analytics. The input is view data for URLs, and can include purchase data for products. These results can show which URLs, such as a video, lead to the purchase of a product (i.e. are related to the purchase of the product).

Reducing the cost of generating recommendations or automated analytics with view data is important since the amount of data can be large. An efficient method that breaks the results into shorter time periods is used to reduce costs. The number of views and common views are calculated for each period, the previous views and common views are reduced by a factor, such as 1/500, and then these terms are added to create a running value of views and common views. These running values are used to calculate the similarity, which, in turn, is used to generate the recommendations or automated analytics.

A completely personalized site shows the recommendations for the user on the front page or landing page, and then recommendations from clicking on those products. It's an alternative way of searching a site from using the search button or item attributes, such as category, price, etc. The site could be a personalized microsite, meaning that the item list is limited to a subset of the complete list. The limited list can be chosen a priori, usually related to a special or social event. Alternatively, the limited list could be different for each user based upon their shopping behavior and related items.

In-store recommendations use smartphones and tablets to display recommendations to a shopper in a brick-and-mortar store. They are optimally based upon sales data or shopping behavior related to the region of that store. The display is simpler than a traditional website and uses swipe and touch features of new devices. Furthermore, with location based services, promotions can be provided based upon where the shopper is located in the store. In addition, maps to locate the recommended products can be provided.

Automated business rules can be implemented by pre-calculating recommendations or re-ordering recommendations based upon rules using products or product attributes. For example, if the shopper is buying a shoe, then the first recommended sock is promoted to be the topmost recommendation. The retailer only needs to create a rule that says when a product is in the shoe category, then promote a recommendation in the sock category to position 1. The rule is used to re-order intelligent recommendations, thus the rule is simple to implement and has intelligent results. The rules are stored as XML in a rule file, such that the code is standard across all retailers, and only the rule file is customized, thus, reducing infrastructure costs.

Driver products create ensemble recommendations that combine all recommendations and sum likelihoods for common recommendations. Influencer products sum likelihoods for common recommendations, and ignore recommendations solely related to the influencer products. Personalized recommendations for the user can be used as influencers for personalized cross-sell or personalized similar, and used as drivers for blended recommendations.

Recommendations in email help increases sales. Email cannot use a Javascript solution for security reasons. Thus, the solution is to have a web service that returns a dynamic image for the recommended product, and link the dynamic image with a dynamic link that redirects to the retailer's web page for that product. The web service combines the thumbnail product image with description, price and ‘Buy Now’ button into one image and returns that image. The same web service redirects the dynamic link to the retailer's product page.

Caching user data, such as recommendations and sales data, in memory increases efficiency and provides the required fast response. On the first call to the service that includes the user ID, or in a special call to notify the service that the user is on the retailer's website, the user data is loaded from a file or database to memory. When the user is inactive for a period of time, like 30 minutes, the user's data is removed from memory.

Disliked products are used to calculate cross-dislikes (if you dislike this product, you will also dislike these), and products that each customer will probably dislike, labeled dis-likely items. Standard correlation techniques are used on disliked products to create cross-dislikes. Dis-likely items are created by combining cross-disliked products for each disliked product for a customer. Disliked products and dis-likely products are removed for recommendations to that customer. Alternatively, similar customers are used to calculate dis-likely products. Similar customers are determined based upon common purchases and/or dislikes.

Social recommendations are generated using correlation between user profile elements on a social network and an online service based upon a standard taxonomy that relates elements between the social network and online service. The relationships are then used to generate recommendation for a specific user.

Furthermore, social recommendations can include which products your friends have bought at the retailer. In order to make this work with the limited attention of users, the products bought by your friends and, optionally, which friends bought each product must be pre-calculated and stored in a database or memory. In addition, the friends can be ordered by the number of purchases at the store, or a ranking system used by the social network. The ranking system can include monitoring actions between friends, or allowing a user to group friends, such as into groups of best, good, okay, and old friends.

Replacement products are related to original products such that the actions, e.g. sales or views, of the original product are used to help calculate recommendations for the new replacement product. In addition, analog products, those that are similar to an original product but not replacing it, can be related to the original product and the actions on the original product are used with both the analog product and original product to calculate the recommendations.

Returns are not included in the calculation of recommendations by exporting the sales data and ignoring returns. The can be skipped in the export or a returns file is used, and sales for returns are removed inside the recommendation algorithm.

Search terms are linked to a standard taxonomy and to selected items or purchased items. Then, the results for future searches in that taxonomy are ordered by number of selections and/or sales of the products.

Remarketing ads follow users around the internet. By including cross-sell or similar items, these remarketing ads can help retailers sell more.

SVD based estimates based upon credit card purchases in stores can be used to predict how much customers will spend in stores, which, in turn can help motivate promotions sent to the credit card holder. The estimates can also be used to determine fraud with unlike purchase patterns.

Selected recommendations are saved in a cookie on the user's computer. This data is then searched when products are purchased to see if they were selected as a recommendation before purchase. This information is used to calculate the uplift for recommendations.

In summary, the following include some of the inventive aspects of this application:
1. A method of pushing recommendations from a manufacturer to a dealer, comprising the steps of:
   a. generating recommendations by said manufacturer,
   b. requesting recommendations by said dealer, and
   c. responding with recommendations to said dealer wherein at least one of the steps utilizes a computing device.
2. The method of claim 1 wherein said dealer does not sell every product of said manufacturer and the recommendations are limited to products of said manufacturer carried by said dealer.
3. The method of claim 2 wherein said dealer and said manufacturer use different product IDs and said different product IDs are linked using text matching.
4. The method of claim 1 wherein said dealer and said manufacturer use different product IDs and said different product IDs are linked using text matching.
5. The method of claim 1 wherein said dealer uses a product ID to determine the manufacturer alias to send with the request for recommendations.
6. The method of claim 1 wherein said recommendations are created using sales data from said manufacturer.
7. The method of claim 6 wherein said recommendations are created using sales data from one or more dealers.
8. The method of claim 1 wherein said recommendations are created using sales data from one or more dealers.
9. The method of claim 1 wherein the recommendations are shown to a user in one of the following from the group consisting of a website, an email, and a social media display.
10. The method of claim 1 wherein the recommendations are manually determined by the manufacturer to promote items.
11. The method of claim 1 wherein the recommendations are determined from sales data, and some recommendations are replaced with manual recommendations determined by the manufacturer.
12. The method of claim 10 wherein the price of the recommended item is included in the response of said recommendations, and the price is displayed by said dealer to a user.
13. A method of creating recommendations, comprising the steps of:
   a. generating recommendations from sales data from a manufacturer and sales data for said manufacturer's products from one or more dealers who carry products by said manufacturer
   b. requesting recommendations from a device, and
   c. responding with recommendations to said device, wherein at least one of the steps utilizes a computing device.
14. The method of claim 13 wherein said dealer and said manufacturer use different product IDs and said different product IDs are linked using text matching.
15. The method of claim 13 wherein said dealer does not sell every product of said manufacturer and the recommendations are limited to products of said manufacturer carried by said dealer.
16. The method of claim 14 wherein said dealer does not sell every product of said manufacturer and the recommendations are limited to products of said manufacturer carried by said dealer.
17. The method of claim 13 wherein the recommendations are shown to a user in one of the following from the group consisting of a website, an email, and a social media display.
18. The method of claim 13 wherein some of the recommendations are replaced with products that are manually determined by the manufacturer.
19. The method of claim 13 wherein the price of the recommended item is included in the response of said recommendations, and the price is displayed by said dealer to a user.
20. A method of pushing promotions, comprising the steps of:
   a. creating a price for each product by said manufacturer,
   b. requesting said price from said dealer, and
   c. responding with said price to said dealer,
   wherein at least one of the steps utilizes a computing device.
21. A method of calculating genomic recommendations, comprising the steps of:
   a. obtaining historical data from numerous users' actions with numerous items, and a target items is linked to a target attribute,
   b. determining the most related attributes to the target attribute, and
   c. for each of the most related attributes, choosing the few top selling items as recommendations,
   wherein at least one of the steps utilizes a computing device.
22. The method of claim 21 wherein the steps (b) and (c) are repeated if not enough recommendations are created in the first pass.
23. A method of automated analytics, comprising the steps of:
   a. obtaining historical data from numerous users' actions with numerous items,
   b. determining the most related items to the target item based upon common actions, and
   c. displaying the most related items for a target item chosen by a client user,
   wherein at least one of the steps utilizes a computing device.
24. The method of claim 23 wherein the actions are only viewed data, and the most related viewed items also utilizes the total views of the target item and total views of the related item during a specific period.
25. The method of claim 23 wherein both view data and purchased data are used, such that viewed items can be related to purchased items.
26. The method of claim 25 wherein when the target item is a viewed item, it is only related to purchased items, and when the target item is a purchased item, it is only related to viewed items.
27. A method of efficiently calculating recommendations or automated analytics, comprising the steps of:
   a. obtaining data from numerous users' actions with numerous items for a specific time period,
   b. combining said data with running values from the previous time periods, resulting in running results, and
   c. utilizing the running results to calculate similarity and determine the related items for a target item,
   wherein at least one of the steps utilizes a computing device.
28. The method of claim 27 wherein the actions are views of items, said running results comprise running views of the target item, running views of the related, and running common views.
29. The method of claim 28 wherein the running results further comprise reducing the previous running results by a factor before adding to the views of the related item in the specific time period, the views of the target item in the specific time period, and the common views in the specific time period.
30. A method of personalized browsing, comprising the steps of:
   a. limiting the items to a limited item set,
   b. showing personalized recommendations from the limited item set when a user first browses the website,
   wherein at least one of the steps utilizes a computing device.
31. The method of claim 30 comprising the additional step of showing similar or related items when the user views an item.
32. The method of claim 31 wherein the limit comprising the additional step of showing similar or related items when the user views an item.
33. A method providing in-store recommendations, comprising the steps of:
   a. Utilizing regional specific shopper behavior to generate recommendations,
   b. Showing recommendations to a shopper in the store,
   wherein at least one of the steps utilizes a computing device.
34. The method of claim 33 wherein the shopper behavior is sales data for that region.
35. The method of claim 33 wherein the location of the shopper in the store is used to affect the recommendations and the location is found from the device's location sensor.
36. The method of claim 35 wherein the recommendations are displayed with a map to find the item.
37. The method of claim 33 wherein the recommendations are displayed with a map to find the item.
38. A method providing automated business rules, comprising the steps of:
   a. creating a rule, where, if the feature product has predefined product attribute elements, and the recommended product has predefined product attribute elements, the recommend product's position in the recommendation list is modified
   b. generating recommendations for a feature product
   c. modifying the recommendation list according to the rule
   wherein at least one of the steps utilizes a computing device.
39. The method of claim 38 wherein the rule promotes recommended products to a higher position in the recommendation list.
40. The method of claim 38 wherein the rule removes recommended products from the recommendation list.
41. A method providing recommendations from driver and influencer products, comprising the steps of:
   a. generating driver recommendations for driver product
   b. generating influencer recommendations for influencer product
   c. combining driver and influencer recommendations where influencer recommendations are ignored if not already a driver recommendation
   wherein at least one of the steps utilizes a computing device.
42. The method of claim 41 wherein the combination includes summing likelihoods for recommendations common to influencer product and driver product.
43. A method providing recommendations in email, comprising the steps of:
   a. having an email call a web service for a recommendation including a product ID or customer ID,
   b. creating a recommended product ID based upon the product or customer ID,
   c. looking up an image and descriptive text for the recommended product ID,
   d. generating a combined image of the recommendation in the web service including a thumbnail product image and descriptive text, and
   e. returning the combined image to the email for display
   wherein at least one of the steps utilizes a computing device.
44. The method of claim 43 wherein another call in said email redirects a link to the webpage for the recommended product such that selecting the image launches a webpage for the recommended product.
45. A method providing cached user data, comprising the steps of:
   a. loading user recommendation data into memory upon first time user is included in call for recommendations, and
   b. using user recommendations to help create the recommendations
   wherein at least one of the steps utilizes a computing device.
46. The method of claim 45 wherein there is a call to load user data.
47. The method of claim 45 wherein the user sales data is also loaded into memory.
48. A method improving recommendations, comprising the steps of:
   a. capturing disliked products for each user,
   b. correlating disliked products to create cross-dislikes
   c. utilizing cross-dislike products to affect the recommendations
   wherein at least one of the steps utilizes a computing device.
49. The method of claim 49 wherein the correlation in step (b) uses the number of common users that dislike a pair of products.
50. The method of claim 49 wherein the cross-disliked products are for each disliked products for a customer are combined to create dis-likely products for each customer, and these dis-likely products are removed from recommendations provided to the customer.
51. A method improving recommendations, comprising the steps of:
   a. capturing disliked products for each user,
   b. determining similar customers
   c. utilizing dislikes for similar customers to affect the recommendations
   wherein at least one of the steps utilizes a computing device.
52. The method of claim 51 wherein the correlation in step (b) uses the number of common purchases for pairs of customers.
53. The method of claim 51 wherein these dis-likely products are removed from recommendations provided to the customer.
54. A method improving recommendations using social profiles, comprising the steps of:
   a. capturing a user's social profile,
   b. organizing the social profile into a standard taxonomy,
   c. using purchases from other users within similar taxonomy, labeled similar users, and
   d. recommending products based upon said similar users' purchases wherein at least one of the steps utilizes a computing device.
55. A method of providing recommendations based upon friends, comprising the steps of:
   a. capturing friends of a user,
   b. organizing what each friend bought at a retailer into resulting data,
   c. loading said resulting data into memory, and
   d. recommending products based upon said resulting data
   wherein at least one of the steps utilizes a computing device.
56. The method of claim 55 wherein said resulting data includes the products bought most often by friends.
57. The method of claim 55 wherein said resulting data includes a list of friends that bought each product.
58. The method of claim 57 wherein each friend is ranked to determine the listing order.
59. A method of ranking friends in a social network, comprising the steps of:
   a. selecting friends by said user, and
   b. ranking said friends by said user into groups,
   wherein at least one of the steps utilizes a computing device.
60. A method of ranking friends in a social network, comprising the steps of:
   a. selecting friends by said user, and
   b. automatic ranking of friends based upon activity between friends,
   wherein at least one of the steps utilizes a computing device.
61. A method of improving recommendations for new products, comprising the steps of:
   a. relating a new product to an original product,
   b. using the actions on the original product to calculate recommendations for the new product,
   wherein at least one of the steps utilizes a computing device.
62. The method of claim 61 wherein the new products is an analog of the original product and does not replace it, and the pre-existing actions on the original product are used for both the original and analog product to calculate recommendations.
63. A method of improving recommendations for returned products, comprising the steps of:
   a. ignoring returns in exported sales data, and
   b. calculating recommendations with said sales data,
   wherein at least one of the steps utilizes a computing device.
64. A method of improving remarketing ads, comprising the steps of:
   a. remembering a shoppers viewed product across websites, and
   b. displaying recommendations for said viewed product in a remarketed ad,
   wherein at least one of the steps utilizes a computing device.
65. The method of claim 64 wherein the recommendations are cross-sell products.
66. The method of claim 64 wherein the recommendations are similar products.
67. A method of analyzing recommendations effectiveness, comprising the steps of:
   a. storing selected recommendations in a cookie on the shopper's computing device, and
   b. searching said selected recommendations for matching products at checkout in the shopping cart.
68. The method of claim 68 wherein the product and sales price are stored in an analytics program to calculate recommendation uplift.

### BRIEF DESCRIPTIONS OF DRAWINGS

FIG. 1A shows the method for pushing manufacturer recommendations to dealers.

FIG. 1B shows the possible sources to generate recommendations for push recommendations.

FIG. 2 shows the updated method for generating genomic based recommendations.

FIG. 3 shows a mobile game-like marketplace using recommendations.

FIG. 4 shows efficient calculation of recommendations or automated analytics.

FIG. 5 shows recommendations for a limited product set

FIG. 6A shows recommendations on a mobile device or in-store kiosk

FIG. 6B shows the recommendation details on a mobile device or in-store kiosk with directions

FIG. 7 shows automated business rules.

FIG. 8 shows how to calculate recommendations with driver products and influencer products.

FIG. 9 shows how to display recommendations in email.

FIG. 10 shows caching users recommendations and sales data for more efficient usage of memory.

FIG. 11A shows one method to remove customer dislikes from recommendations.

FIG. 11B shows another method to remove customer dislikes from recommendations.

FIG. 12A shows recommendations influenced by a user's social profile.

FIG. 12B shows recommendations based upon friend's purchases.

FIG. 12C shows how to rank friends in a social network.

FIG. 13A shows the replacements file structure.

FIG. 13B shows how to use existing actions on existing products to improve recommendations for new products.

FIG. 14 shows a novel method to handle return data.

FIG. 15 shows a retargeting ad with a cross-sell.

FIG. 16 shows how to use cookies and analytics to calculate uplift.

### DETAILED DESCRIPTION OF THE INVENTION

### 1. Terminology

Regarding terminology, items include products, news, articles, items, songs, movies, images, web pages, etc. The terms products and items are used interchangeably. Users include customers, consumers, recipients (such as for email), or anyone browsing or interacting with the web page, website, or any item. These terms are also used interchangeably. Websites and web pages are not limited to their current implementation, but also refer to information that is available through a network to any device, including computers, televisions, mobile phones and other mobile devices (e.g. iPad). Actions include purchases, plays, rentals, ratings, views, reading an article or any other usage or action, unless specifically limited. Social networks or social media are services like MySpace or Facebook, where users have a profile and interact with other users, either directly, or within groups. Mobile commerce is the purchasing of products on mobile devices, usually cell phones or smart devices, such as an iPhone or Android. Attributes are characteristics of items or users, such as category, brand, collection, weight, color, gender, and so on. Crowd based recommendations are based upon the activities of users directly on the items, e.g. ‘Customers who bought this, also bought these’. Genomic based recommendations, previously called categorical recommendations in patent application Ser. No. 12/764,091, are based upon activities on the item's attributes and then applied to the target item. Recommendations and analytics can be used interchangeably since recommendations are automated, intelligent and predictive analytics.

### 2. Push Recommendations

Many manufacturers want to sell more through their dealers, as well as (or instead of) selling more on their website. They also want to push promotions to their dealers.

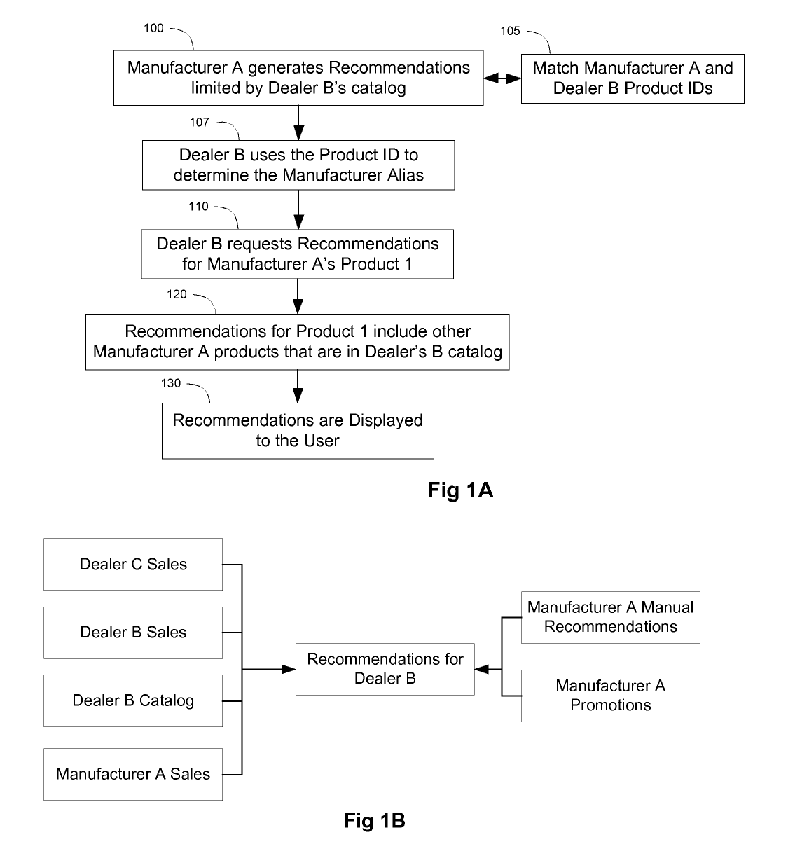

In this embodiment, manufacturers sponsor recommendations of their products on their dealer's (i.e. retailers) website. Specifically, when looking at Manufacturer A's Boots on Dealer B's Website, Dealer's B Website receives recommendations for gloves and socks from Manufacturer A. Preferably the recommendations are paid for by Manufacturer A. The process is shown in FIG. 1A.

The process begins with generating recommendations limited by Dealer's B catalog, as shown in box 100.

The potential sources to generate recommendations are shown in FIG. 1B. An intelligent recommendation generator process uses action data supplied by the manufacturer, action data supplied by one or more dealers, or both. It usually only includes the manufacturers sales data. This process automatically generates recommended items for each target item using action data such that products are acted on together (e.g. customers who bought this item, also bought these).

The recommendations may also be manually entered by a person sponsored by the manufacturer (such as an employee or consultant), such that the person believes the target item and recommended item will increase the number of actions. The manual recommendations can also link a recommended product to a category. The target and recommended items may be similar items to help convert browsers to buyers, or related items that are bought together (a.k.a. cross-sell). Finally, promoted items may be recommended.

The promotion and target item may or may not be similar or related. In other words, the promotion item may just be an item that the manufacturer wants to promote. The manual entries or promoted items can replace one or more intelligent recommendations, if both systems are used. These entries can be forced into a recommendations position (i.e. first, second, etc.), or given a weight or likelihood and dynamically placed according to the weights of the intelligently generated recommendations.

The generator must match the identifiers (known as product IDs) for manufacturers and dealers, as shown in box 105. Ideally, universal SKUs, UPC codes or IDs are used. If different product IDs are used, the dealer must upload their catalog of products by that manufacturer with, at a minimum, names and product ID. The recommendation generator uses product names to create a lookup table that links product IDs from dealer to manufacturer. The manufacturer to dealer IDs are linked if names exactly match, preferably ignoring white spaces. If there's no exact match, the names with the most matching words or characters are used. The system can create matching weights for each name, and then create the best match. Alternatively, it can find the best match for each name, and remove the match. In the preferred embodiment, exact matches are removed when matched, and similar names are stored by weights, and then matched after every name has been evaluated. The lookup table includes the manufacturer product ID and linked dealer product ID on each line. Preferably, it is a pair of tables, one indexed by manufacturer product ID and the other indexed by dealer product ID. This enables quick look-up in either direction.

Furthermore, dealer B may not carry all of the manufacturer's products. Thus, when the intelligent algorithm creates recommendations for dealer B, it limits the products to those carried by dealer B. In one embodiment, the products not carried by dealer B can be removed from the sales data. However, if an algorithm uses product attributes, it may be best to include all sales data, but then limit recommendations to include products carried by dealer B. In this embodiment, the generator algorithm removes the products that are not carried by the dealer during the process to determine similarity (in terms of cosine similarity as described in application Ser. No. 12/764,091, also known as likelihood of action). By removing the products before adding them to the recommendation list, the algorithm guarantees there's space in the recommendation list for products carried by the dealer. If recommendations are generated, and then the products are removed, there's the possibility that every recommendation is not carried by the dealer. In this case, the system defaults to top sellers by that manufacturer, which is not as effective as related or similar items.

The recommendation engine receives a request and responds with the recommendations. The recommendation response can be a list of product IDs (using Dealer B product IDs not the manufacturer product IDs—if they don't match), or product thumbnail images. For the latter case, the images or links to the images are uploaded with the dealer's catalog during the generation process. The images are in a table or iFrame. The requesting system can be a web server or browser (i.e. a device) that is associated with an IP address.

The recommendation engine can be a web service, or based upon any web protocol, such as PHP, Perl, Ruby, J2EE, .NET, and so on. When displaying recommendations on a website, the recommendation request can be called from a web server, probably in the same language as the engine, or from the browser, usually using Javascript (or Jscript). Preferably, the recommendation engine is hosted by a third party and the dealer calls the same engine for products from several manufacturers.

The request also include a unique dealer alias for that manufacturer. Alternatively, the manufacturer alias and dealer alias are both included, so that a dealer has one alias across all manufacturers. The request can also include number of recommendations, and starting position, where the starting position is used to change recommendations each time the webpage is viewed.

The dealer determines the manufacturer of the item from their catalog database. If that manufacturer provides push recommendations, the dealer converts the manufacturer's name into a manufacturer alias or unique alias for that dealer and manufacturer pair. The proper alias and service location (i.e. web address) is included in the request.

Alternatively, the recommendation engine can use the target product ID in the request to determine the manufacturer, and convert it to a manufacturer alias. The dealer alias is included in the request such that the proper recommendations are returned. This alternative method assumes that all manufacturers that provide products to the dealer use the same recommendation vendor.

The request can come from any connected device, such as email server, mobile device, smartphone, or Dashboard in the Intranet. The system can be used for recommendations for email, mobile devices, catalog phone orders, online chats, social media, and so on.

In simple terms, the dealer calls for recommendations, receives recommendations within that manufacturer's product line, and the manufacturer is charged; thus, the dealer gets free recommendations and the manufacturer sells more stuff.

The recommendation response includes recommended product IDs or thumbnails, as previously discussed. It can also include likelihood, description and price. Including the price enables a push model, where manufacturers can place an item on sale and immediately every dealer has the new price. Some dealers will ignore the price as they will want to determine the price, especially if they have already bought the inventory. This issue can be handled with dealer rebates to move slow moving products, preferably the rebates are electronic and immediately cause a transfer of funds between the dealer's bank and manufacturer's bank. Promoted items can be forced into every recommendation with a manual entry, or only when the target item is related to the promoted item (i.e. reduced price).

Furthermore, this system can be used without recommendations to push a price reduction out to dealers. For example, a dealer sends a request with a product ID, and the response includes the price. The request could be made once an hour, and the response includes the price of every item in the dealer's catalog from the manufacturer.

Additionally, this system can be combined with recommendations created by the dealer. These dealer recommendations can be intelligent or manual. If similarities or likelihoods are included, the recommendations are combined in order of preference as determined by the similarity or likelihood value. Alternatively, a hierarchy can be used. In this approach, the combine solution first looks to see if push recommendations from the manufacturer of the product exist, and, if they exist, uses them. If they don't exist, the solution provides recommendations of the dealer's products from the dealer's sales across most or all of the manufacturers.

### 3. Recommendations with a Limited List

When sending recommendations in email or printing discounts such as linked to affinity cards, the retailer may want to limit the recommended products to a small list. For example, the retail store may have 10 items behind the counter and want to determine the best of these 10 items. In this case, it is not optimal to find an item from the limited list in the recommendations since it is likely that the 20 or so recommendations do not include an item from the limited list.

In this case, when adding items to the likely item list, the item should belong to the limited list, or not added. Thus, each recommended item will be from the list.

In a different embodiment, recommendations can be limited to have fewer than a ‘user chosen’ number of items from a specific attribute. For example, if the first three recommendations for a boot are different socks and the user has limited recommendations from an attribute to 2, the third sock is ignored and the fourth recommendation is used. If there is no fourth recommendation the algorithm preferably goes back to the first un-used recommendation and adds it, and then moves down not adding any item from that category. The process is repeated until every un-used recommendation is used, or the requested number of recommendations is met.

### 4. Recommendations in Mobile Commerce or Retail Games

People love playing with their iPhones. In this novel game-like interface, recommendations are used to increase sales, either on an iphone, mobile device or on a PC using a Dashboard interface.

The user can select target items in several ways. The user can enter text, every matching target item is shown, and recommendation for all displayed target items are combined and shown. The user can narrow the list by selecting target items to remove or to include in the target list. The user can select an item from a drop down list, or select multiple items. The user could take a picture of the item or its barcode, and image recognition and a database converts the image into the product's name. Using the bar code and a database of UPC codes is easier than recognizing the picture of the product with a database of product images.

Next the user can select one or more retailers to limit the recommendations to products carried by the selected retailer(s).

The recommendations are preferably ordered by similarity or likelihood of purchase to the target item(s), as known in the state of the art. The recommendations show price and retailer store. The user can select a recommendation and be linked to the retailer's website, and purchase the product. Affiliate fees for sales, such as a percentage of sales, are preferably used as the business model for the recommendation vendor. The user can purchase directly from the game.

### 5. Recommendations Limited by Attribute and Improved Genomic Recommendations

This method works for both crowd based recommendation and genomic based recommendations. Recommendations can be limited to have less than a ‘user chosen’ number of items from a specific attribute. For example, if the first three recommendations for a boot are different socks and the user has limited recommendations from an attribute to 2, the third sock is ignored and the fourth recommendation is used. If there is no fourth recommendation the algorithm preferably goes back to the first un-used recommendation and adds it, and then moves down not adding any item from that category. The process is repeated until every un-used recommendation is used, or the requested number of recommendations is met.

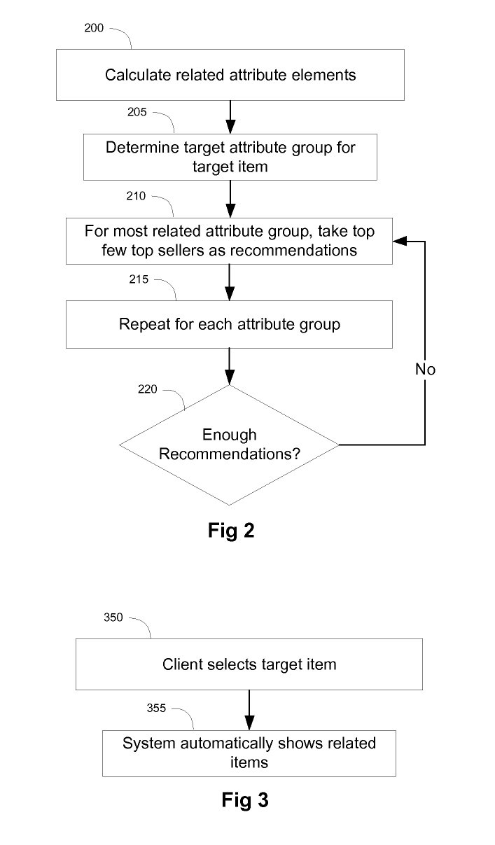

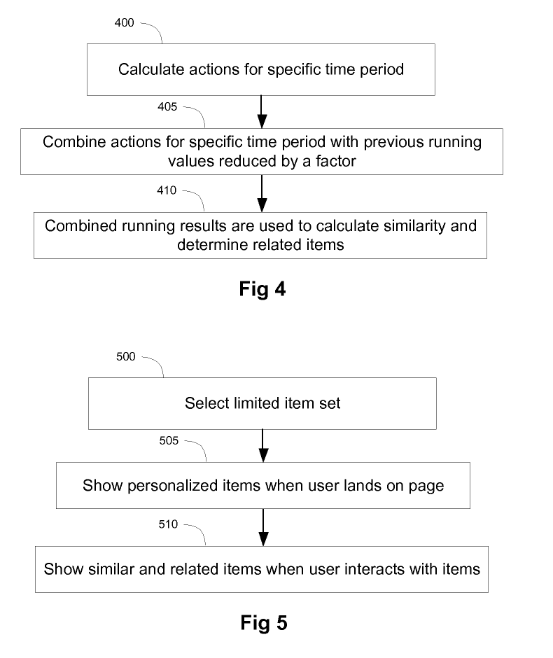

As shown in FIG. 2, for genomic based recommendations, the recommendation process begins as described in our prior patent application. The related attribute elements are found for each attribute, such as using similarity calculations. Then, for the target item, the target attribute elements are determined, and an attribute group with one attribute element from each attribute is determined. For example, if the target item is in the category backpacks (where backpacks is the attribute element for the category attribute), and brand Dakine (where Dakine is the attribute element for the brand attribute), the target attribute group is (Backpacks, Dakine). Each attribute group has a similarity to this target group by multiplying the similarity of the first attribute element times the second attribute element. Since a target element may have several attribute elements in each attribute (e.g. Backpack element and Special Deal element for category attribute), each target element can have multiple attribute groups, and each group is used in the next steps. Next, the system takes the most related attribute group and then the top few (e.g. 2) selling items in that attribute group. (This is different than done the referenced application Ser. No. 12/764,091, where calculating the likelihood for a recommended item includes multiplying the group similarity by the number of sales and a scaling feature and using the resulting likelihood to order the recommendations.) The method then goes to the next attribute group and chooses the top few sellers. The method repeats with the first attribute group if not enough recommendations are found after going through all related attribute groups. The attribute group is preferably one or two attributes, but can be any number of attributes.

### Efficient Genomic Recommendation Storage

Genomic recommendations can be more efficiently stored than storing them for each item since an item with the same two attributes will have the same genomic recommendations. Thus, genomic recommendations for two attributes can be stored for each possible pair of attributes. The system can also only include pairs of attributes that occur for existing products. Thus, if no product is attribute 1 element c and attribute 2 element d, then that attribute pair (c,d) is not stored. This means that if there are 50 elements in attribute 1 and 10 elements in attribute 2, and 30,000 products. Rather than storing 20 recommendations for 30,000 products, there are 20 recommendations stored for 500 attribute pairs.

In the implementation, the genomic recommendations for a product are determined from its attribute pair and the stored recommendations for that attribute pair.

### 6. Recommendations among Friends

A social network can be used to improve recommendations. In one preferred embodiment, recommendations are generated from the actions of friends, as opposed to from all actions in the social network. The actions can be on any website which is obtains the friends list from a social network, or actions within the social network.

Furthermore, the recommendations can be limited to the friends with whom the user actively shares information, such as pictures, conversations, etc. These are friends who post on the user's wall, who the user responds to, the user posts on their wall, the user is in several groups with them, and other online social activities.

The item recommendations can be calculated based upon activities (as described in patent application Ser. No. 12/764,091) and limited to these active friends—or—suggestions from the active friends on which online items that the user should consider.

Specifically, rather than looking at common actions across all users in the social network, only common actions among friends.

### 7. Automated Analytics and View Data

Automated analytics are discussed in the patent application Ser. No. 12/764,091 (page 57-59) regarding products. This concept can be extended to view data and web pages in general. Specifically, for a target item selected by a client user, the related viewed items are shown, meaning that these items have been viewed by the same user resulting in the highest similarity (noting that similarity can be normalized by number of sales or views of the target and displayed items, not solely based upon common views). Please note that the client user is a person belonging to the client organization that is interested in usage of the website, such as the website owner. It is a different person than the user of the website, who can be anyone in the world.

If the item is a web page, this method automates web analytics. For example, a common question is that the website owner wants to know if watching a target video causes the sale of a target product. In traditional web analytics, this requires special programming to track the video and sale of the product which is costly. In this novel usage, the video has an unique item ID (e.g. its URL) and the product has an unique item ID (e.g. its SKU), and, when the inputs to recommendation generator are viewing of URLs and purchase of products, the similarity automatically shows the likelihood that the watching the video leads to the sale of the item. In fact, this novel method automatically shows that viewing of a different video or web page leads to the purchase of the target product, or that the viewing of the target video results in the purchase of a different product.

As a side effect, the system will also show which products are bought together or which URLs are viewed together. Preferably, the system can limit the generation of ‘recommendation pairs’ to include only similarity of a view item and purchase product; thus, not including viewed items to viewed items and purchased products to purchased products. In this case, when the target item is a viewed item, the system only calculates similarity of purchased products to determine related items when the target item is a viewed item. Equivalently, when the target item is a purchased item, the system only calculates similarity of purchased items to determine related items.

This system is much simpler than traditional analytics because the special report does not need to be written. The system only needs to track item views and product purchases and send to the ‘recommendation’ system.

View data also requires tracking of user IDs, as opposed to purchase behavior which has a user ID associated for shipping. To track user IDs, Javascript is used to write to a cookie. The cookie includes (i) cookie ID, (ii) user ID, (iii) remember me flag, and optional (iv) date. Privacy requirements may require the cookie to be deleted after a certain number of days, such as 90 days, unless the user opts-in, which is stored in the remember me flag. The Javascript writes a cookie ID for an anonymous user, and that ID is used until the cookie is deleted (and forever if the user selects remember me). If the user logs into the website, the user ID is added to the cookie, and the user ID is used thereafter. In other words, if a user ID exists in a cookie it is used rather than the cookie ID. The previous data can be updated with the user ID replacing the cookie ID, improving accuracy. Then, each time the user views an item, the cookie or user ID is sent to the server for storage and processing. This can be a stand-alone web service call to let the recommendation/analytics software know that the user viewed something, or a call for recommendations that has a field that also tells the recommendation software that an item has been viewed. In the latter case, a GetRecommendations( )web service call returns recommendations, and a flag that states this is from a product page (meaning it is view data) tells the server to also store this item ID and user ID as view data. If this call has a flag for search results, category page, cart, etc., the item is not stored as view data.

The tracking of user IDs helps all recommendations, even those based upon purchase behavior since a user ID can personalize cross-sell recommendations. It can also be used to relate historical purchases via a cookie ID to a user after they create a logon and user ID.

Alternatively, if it is important to track view data for a long period of time, the amount of data allowed can be limited by tiers, where higher tiers allow more view data and cost the website owner (i.e. retailer) more.

### 8. More Efficient Recommendations

### View Data and Automated Analytics

To reduce costs of a recommendation system, the computer usage in the generation of recommendations should be minimized. This is very important in viewed items, such as web pages, since many websites have millions of viewed items per months, and only 2% conversion to purchased items, thus many fewer purchased items. It is also important for automate web analytics since there are millions of views per month. For example, with 100K web pages and 100M views (a year of data), it will take a PC with 4 GB RAM several hours to calculate the automated analytics (a.k.a. ‘recommendations’) with the most efficient method of grouping actions by both item and user as described in the referred patent application Ser. No. 12/764,091. This efficient method is not limited to view data, and can be used with purchase data—although for midsize retailers with minimal purchases, it is best to use purchase data over a very long period, like a year.

For view items or relationships between views and purchases, what I viewed a few weeks ago is less important to what I viewed and possibly purchased today. As such, the similarities can be calculated in a short time period and then adjusted for each new time period, where the time period could be one day. The similarity can be calculated with total activities and common activities saved at the end each period. Then, for the next period, these activities are reduced by a factor, f, resulting in the equation: y[i]=x[i]+(1−f)*y[i−1]; where y is the resulting activity and x is the new activity for that period. In other words, the effect of historical actions is reduced over time.

This can also be used for purchases if it is idea to only look at purchases within a cart as opposed to across time. The day of view data is like a cart.

For example, if calculating view data, the period is a day, and the factor is 1/500, the following calculation is done at the end of each day. The variables are as follows, the results for the number of views for the target item is N_{T}, the number of views for the related item is N_{R}, and the number of common views is N_{C} where common is the number of users that viewed both the target and related items, the given number of views today for the target item is N_{TT} and related item is N_{RT}, and the common views today is N_{CT}:

N_{T}=N_{TT}+499/500*N_{T}[end of yesterday]

N_{R}=N_{RT}+499/500*N_{R}[end of yesterday]

N_{C}=N_{CT}+499/500*N_{C}[end of yesterday]

And, an example resulting similarity is:

Similarity=N_{C}/(sqrt(Nᵣ*N_{R})+Nₜₕ); where the threshold (Nₜₕ) is 10 or so.

This is similar to a traditional low-pass filter, and any low pass filter could be used.

Furthermore, some users may be in the middle of a browsing session during the period cutoff. This session can be ignored such that the view data is included with the period in which it was viewed. However, it is possible to move their view results to the period in which the browsing session ends, where the end is defined by a certain period of time in which no action happens on the website from that user.

### 9. Personalized Website

Typically, users move through websites by utilizing categories or search. For example, on a retail store, the shopper selects that they want socks, or searches for wool socks. Then, they are shown socks, usually organized by price or popularity.

Personalization can provide a different way to browse a website. When the user lands on the front page, the items are personalized to that user, meaning they are the items that the user will most likely act upon (e.g. products to purchase). If the user is anonymous, the website can start with top items (e.g. top selling products), or a predefined selected list of items. Then, when the user clicks on an item, the item is shown with similar and cross-sell items related to that product and the user, a.k.a. personalized cross-sell. Any methods to determine personalized similar (i.e. alternative) or personalized cross-sell can be used (including those in patent application Ser. No. 12/764,091).

A microsite is a smaller website from the main website. For a retailer, it could be a store with a few items, like a gift guide, and it can be in a social setting, such as facebook.com/brandX. Standard recommendations can be included with this microsite, such that for every product on the site, there are recommendations of what else can be bought, either from the full catalog or limited to the products on the microsite.

This microsite could be completely personalized to the user with the items limited to a subset that is special for the microsite, such as those on special, related to some event like a sports event, or any social marketing opportunity. In other words, the browsing experience on the microsite is unique to each individual with a limited item set. The generation of recommendations can utilize the actions of all items for optimal learning, and, then, limit the recommendations to the limited item set (as discussed above). Alternatively, the generation can only include actions on the limited item set.

Alternatively, the limited item set is a personalized item set is different for each user based upon their previous browsing behavior, and similar or related items to the personalized item set. Similar or related items are those likely to be utilized instead of the item (similar) or utilized with the item (related). This provides a completely personalized browsing experience that maximizes the engagement with personalized items, and sells deeper into the catalog with items related to these personalized items.

### 10. In-Store Recommendations

There are three trends in stores. First, people are using their smartphones, such as iPhones, to price compare items and leave the store. The stores need to have an app on the smartphone that provides additional information, and part of that information is recommendations. Second, tablets, such as iPads, are an inexpensive way to add kiosks to a physical store. This expands the packaging of the product to an interactive experience. Part of the information on the kiosk is recommendations. Third, stores are giving tablets to employees so they can provide information to shoppers, such as inventory or location of products, without walking back to their stand. Automated recommendations provide the combined intelligence of all sales people for this sales person. For example, when they are helping you at Home Depot with sheet rock, they can look at their tablet and say that tape is on isle 7 and screws on isle 8. This example requires products being linked to the store isle in a product catalog database, which is standard for most stores.

For many stores, especially apparel, the recommendations should be generated from stores in the same region. For example, recommendations of clothes in Portland, Oreg. will be different than in Sarasota, Fla. The data can be accumulated by region, such as for each state, and used to generate the recommendations. Specifically, aggregate sales data and/or view data in each state can be used to generate the recommendations for each store in that state. Furthermore, when using tablets, the shopper is anonymous, and the recommendations must work for unknown shoppers. Specifically, the recommendations cannot be based upon previous purchases or browsing behavior for that shopper. The aggregate sales data and product catalog with attributes, such as brand and category, is optimal for recommendations in this case. With store affiliate cards, the device could have a card reader, which does not even require a card swipe with modern and future RFID technology, to identify the shopper. An identified shopper's product viewing and purchase behavior can be tracked to improve and personalize recommendations, along with aggregate shopper behavior and purchases (as known by those familiar with the prior art in recommendations).

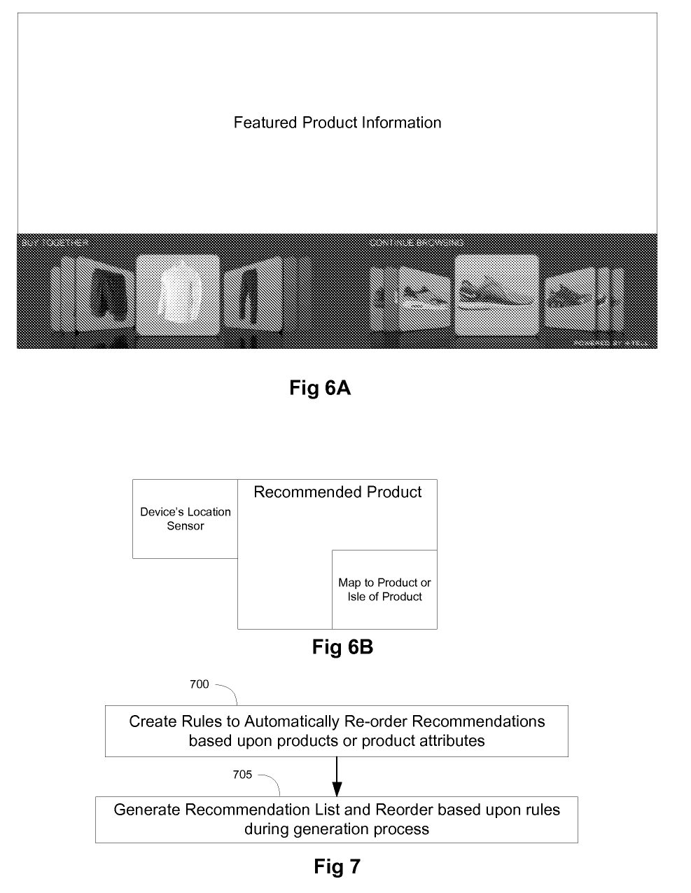

When showing recommendations on a smartphone or tablet, the existing website is usually too detailed. The shoppers are hurried within the store and don't have as much time or focus to read like they do in the privacy of their home with a website. As such, the interactive display, including recommendations should be simpler. For example, in FIG. 6, we show a simple website with two types of recommendations: similar items that are bought instead of the viewed item since the viewed item is not correct, labeled with ‘Continue Browsing’, and cross-sell items that are bought with the viewed item, labeled ‘Buy Together’ (or ‘Also Bought’). In this example, the touch screens are used to swipe through recommendations. With a swipe of the finger, the recommendations for either section are shown like pages of a book. When you tap a recommendation, a pop-up window shows you more information about the recommendation, and offers a buy now or you can click on the recommendation so it becomes the featured product.

Since location based sensors are included in these modern devices, and the sensors are getting more accurate, and able to provide your location in the store by isle (possibly requiring additional location equipment in the store). In addition, stores have databases that know what items are in each isle (as well as what isles each item is located), and preferably where in the isle. With isle location and this database, the recommendation system can compare items in the isle to items that the shopper is likely to buy, and present location-based recommendations of items in that isle, or personalized coupons for items in that isle the shopper is likely to buy. Furthermore, the device can provide a map of where the product is located, as well as list of locations of similar and cross-sell products.

This list of locations and map to other recommended products can be provided for any product that the shopper is looking at—just as done for the store employee in the Home Depot example above.

### 11. Automated Business Rules

Many retailers want to control and improve automated recommendations, but it's too time consuming to look at each product. Thus, they want automated and intelligent business rules. For example, when looking at a shoe, they want two pairs of socks and a shirt recommended. However, they don't want to show a dress sock with a running shoe. Automated and intelligent business rules re-order the automated and intelligent recommendations to match the desires of the retailers, as shown in FIG. 7. For example, the running sock that is bought with the running shoe as the third most likely recommendation is promoted to the first recommendation based upon the previous example rule.

In general, there are several rule types, as shown below. Attributes are groups like category, brand, etc. An element of the attribute is the specific element of the group, like shoes or socks for categories or Columbia or Icebreaker for brand. The feature product is the product for which the recommendations are being generated. The feature product belongs to one or more feature attribute elements. When this spec states that a feature product is in the feature attribute element list, it means that the feature product has an attribute element that is part of the list.
1. If in <Feature Attribute Element List> then <only, do not, or favor> recommend products in <Rec Attribute Element List> by likelihood <Weight (only for favor)>
2. Never recommend in <Feature Attribute Element List> unless in <Rec Attribute Element List>
3. <Only, Never> recommend in same <choose attribute1 or attribute2> or/unless <Rec Attribute Element List>
4. If in <Feature Attribute Element List> then <do, or do not> recommend <Rec Products> with likelihood <Weight (only for do)>
5. If <Feature Product> then <do, or do not> recommend <Rec Product> with likelihood <Weight (only for do)>
6. If in <Feature Attribute Element List> then promote recommendation in <Rec Attribute Element List> to position <Pos>

The implementation runs the rules. The rules are run at different times during the generation of the recommendations.

Rules 1, 2 and 3 are implemented each time the correlation of cross-sell products is calculated. If the rule 1 is ‘only’, the cross-sell product is ignored if not in the Rec Attribute Element List. If the rule 1 is ‘do not’, if the cross-sell product is in Rec Attribute Element List, then ignore it in the recommendations. If using the ‘favor’ rule 1, then if the cross-sell product is in the Rec Attribute Element List, the Weight is added to the correlation, and the cross-sell product is ordered in the recommendation list according to this combined correlation value. For rule 2, if the cross-sell product is in Feature Attribute Element List, it is ignored in the recommendation list, unless it is in Rec Attribute Element List.

Rules 4 and 5 are used to preset the correlations and prefill the recommendation list. In patent application Ser. No. 12/764,091, it is used to prefill the similarity array (stores correlations, which are also known as likelihoods of buying the products together) before calculating the similarity for each product pair. The recommendations are then re-ordered based upon the size of the correlation. For the ‘do’ rule 4, if the feature product is in the Feature Attribute Elements List, then add the rec product(s) to the recommendation list with the defined weight. For the ‘do not’ rule 4, give the rec product(s) a large negative correlation so it is not included in the recommendation list for feature products in the Feature Attribute Element List, even if the crowd based recommendation find a correlation (as this correlation is canceled by the negative value). For the ‘do’ rule 5, for the feature product, add the rec product(s) to the recommendation list with the defined weight. For the ‘do not’ rule 4, then give the feature product a large negative correlation so it is not included in the recommendation list for the feature product.

Rule 6 is implemented after the recommendation list is created, and re-orders the list. For rule 6, if a feature product is in the Feature Attribute Element List, the first recommended product in the Rec Attribute Element List is promoted to position Pos. If no products belonging to the Rec Attribute Element List is included in the recommended list, the top selling product in the Rec Attribute Element List is moved to position Pos.

The storage of the rules in a rule language is important. The rules can be stored in multiple files so that rules created in an online control panel are kept separate from rules created by the retailer directly to the file. In addition, product to product recommendations (rule 5) is usually stored in a separate file so it can be exported or created by the retailer's purchaser. This means that the purchaser of products, who knows the relationship (e.g. bikini bottom and top, or snowboard and binding) does not have to relay the information to the marketing or merchandising person who creates product to product rules. Rules files enable a common program to be customized for each retailer.

Storage is in an XML file, where
XML examples need to keep track if elements are attribute 1, attribute 2 or filter attribute
Each rule type has a specific storage, where rule 1a is rule 1 with only, rule 1b is rule 1 with do not, etc.

Some examples are shown below:

```
<rule type=”1” name=″Shoes with Socks″ >
  <condition type=”input” >
    <attribute=″att1″ name=″shoes″/>
    <attribute=″filter″ name=″women″/>
</condition>
<condition type=”output” >
      <attribute=”att1” name=”socks” />
  </condition>
  <action verb=″only″/>
</rule>
<rule type=”1” name=″Shoes Not Together″ >
  <condition type=”input” >
    <attribute=″att1″ name=″shoes″/>
  </condition>
  <condition type=”output” >
    <attribute=”att1” name=”shoes” />
  </condition>
  <action verb=″not″/>
</rule>
<rule type=”1” name=″Shoes for Men Favor Socks 10%″ >
  <condition type=”input” >
    <attribute=″att1″ name=″shoes″/>
    <attribute=″filter″ name=″Men″/>
  </condition>
  <condition type=”output” >
    <attribute=”att1” name=”socks” />
  </condition>
  <action verb=″favor″ weight=”0.1” />
</rule>
```

### 12. Drivers and Influencers

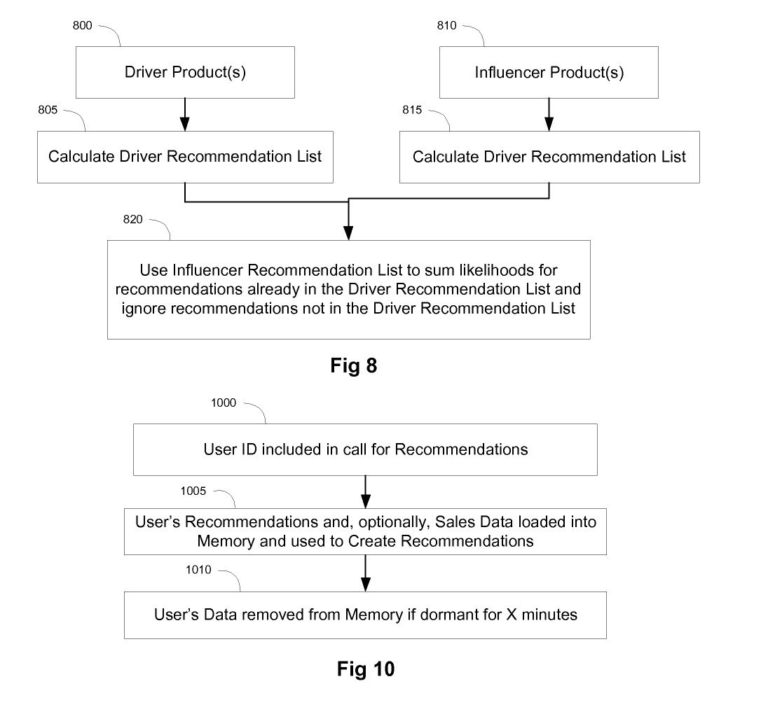

As described in patent application Ser. No. 12/764,091 in section ‘Likely Items and Likely Users’ on page 27, and section ‘Combined Results’ on page 36, recommendations for products can be combined to generate recommendation for an ensemble of products. If there are multiple driver products, like 3 products in the cart, the recommendations for each product are combined, and common recommendations have the likelihood correlation added. If there is a driver product and influencer product, the recommendations are combined such that all recommendations from the driver product are used, but only the recommendations from the influencer that are also recommendations for the driver. This is shown in FIG. 8. In other words, if the influencer recommendation exists in the driver recommendation list, the likelihoods are summed, otherwise, the influencer recommendation is ignored. Thus, the influencer only influences the existing recommendations, and does not add new recommendations to the list. If there are multiple driver products and multiple influencer products, the ensemble recommendations for driver products is first created, and then, for each influencer product, the previous steps are done on the ensemble recommendations.

The driver can be a viewed product on the product detail page, and the influencers can be products in the cart and/or wish list. Thus, the customer's behavior as evident in the shopping cart or wish list, influences which recommendations are shown.

This is similar to personalized cross-sell, as defined in the previously mentioned patent application on page 36, lines 29-34, where the likely items influence the cross-sell.

### 13. Dynamic Email

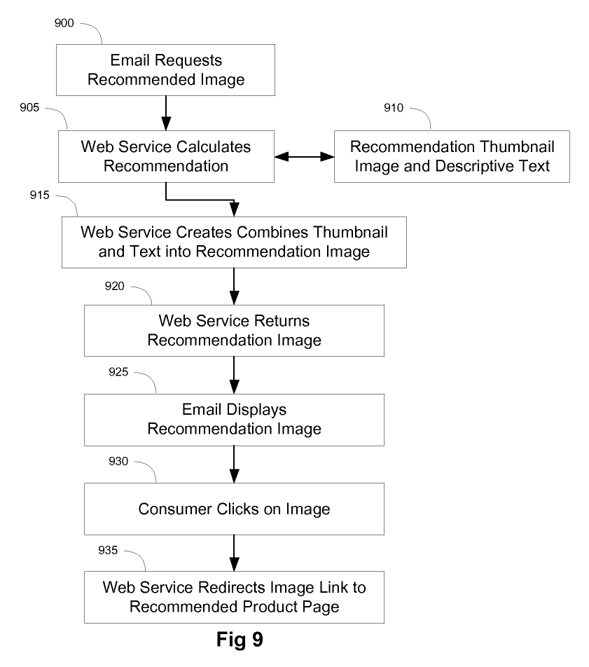

Recommendations in email are critical. Similar and cross-sell items in abandoned cart emails help increase sales. Personalized up-sell and cross-sell in monthly newsletters, and order and shipping confirmation emails also greatly helps increase sales. Email cannot use a Javascript solution since email readers block Javascript for security reasons. Thus, the solution is to have a web service that returns a dynamic image and redirects the link to the recommended product, as shown in FIG. 9.

This allows the email reader software, like Microsoft Outlook, to include the recommendations upon opening the email. In addition, as most good recommendation systems handle inventory so that they don't recommend out of stock items, the recommendations will be in stock and can change each time the email is open. For most email readers (due to security), the user must select to download images.

Dynamic emails are created as following, requiring both a product image and product page link:
1. Use a REST web service call to an image in the img src of the email
2. Inside the web service, combine the product image, name and price into an image, such as using C#.NET drawing functions
3. Return the combined image
4. Redirect the link with the web service call to the proper page

In the email template place the following code, where <product IDs> and <customerID> is replaced with actual values by the email program for each email. MyAlias and recPos are set by the client for the email template. recPos is set to 1, 2, etc. based upon where it is in the email, and how many recommendations are called. Result should have the extension (jpg, png or gif) to match how the client saves the images.

An example code for combined images is: www.4-tell.net/Boost2.0/rest/GetRecIDs/email?clientAlias=MyAlias&productIDs={productIDs} &customerID={customerID}&startPosition=recPos&resultType=0&format=json&result=image.jpg

An example dynamic product page link is: www.4-tell.net/Boost2.0/rest/GetRecIDs/email?clientAlias=MyAlias&productIDs={productIDs}&customerlD={customerID} &startPosition=recPos&resultType=0&format=json&result=link.html

Inside the web service the product image is created with an IEmail interface. The call creates the image.
1. It calculates the recommendations.
2. For the recPos, it obtains the image, name and price
3. It combines these objects into an image using C#.NET drawing objects
   a. The text for the name and price are drawn below the image, and may add a ‘buy now’ button
4. It returns the image—needing to match whether the base image is gif, jpg or png.

Inside the web service the product page link is redirected with an IEmail interface. The call creates the link as follows:
1. For the recPos, it obtains the page link
2. It redirects to the page link by returning <meta http-equiv=“refresh” content=“0;url=}page link}”> where {page link} is replaced by the actual value in the web service

This allows the email reader to display an image of the recommended product and have that image link to the retailer's webpage for that product, such that clicking on the image launches a browser to view the details about the product and buy it.

### 14. Caching User Data

Our system stores 20 recommendations for each user and product in memory. This only requires simple math to create ensemble recommendations for various products and users, as described in section 12; thus, enabling very fast response and efficient use of memory. Research has shown that ecommerce web pages should load in under 1.5 seconds, or shoppers are likely to leave.

Stores have many more users than products. (As an aside, this is why it's more efficient to calculate recommendations based upon products than users.) Thus, the users take more memory for recommendations than products. Using less memory lowers the cost of the solution since recommendations for more retailers can fit on one machine of fixed memory size. In addition, users are not as random as products. A user is on the site for a while and then gone, whereas any product can be viewed at any time, thus required for a recommendation at any moment.

As shown in FIG. 10, the solution is to not store all of the users' recommendations in memory, but only those that have recently visited the site. The user's data is stored in a file or database. Similarly, the user's list of previously purchased products can be cached into memory so that previously purchased products are not recommended to that user, if desired by the retailer. Specifically, when looking at a product, cross-sell products (e.g. a couch) that the user has bought are not shown to the user (as predetermined in the resell flag by the retailer).

The implementation is that the first time a user is included in a call for recommendations, the user's recommendation and, optionally, their sales data, is loaded into memory. If 30 minutes (or any time period) go buy and the user has not been included in a call for recommendations, the user's data is removed from memory.

In addition, the retailer or provider can configure the system such that the user is ignored the first call since it would be slow to wait for the user's data to be loaded. Then, the user's data is used in subsequent recommendations.

Similarly, a separate call can be made that informs the recommendation system that a user is on the retailer's website, so that the user data is loaded into memory—preferably before the first call for recommendations for that user.

### 15. Interactive Recommendations and Dislikes

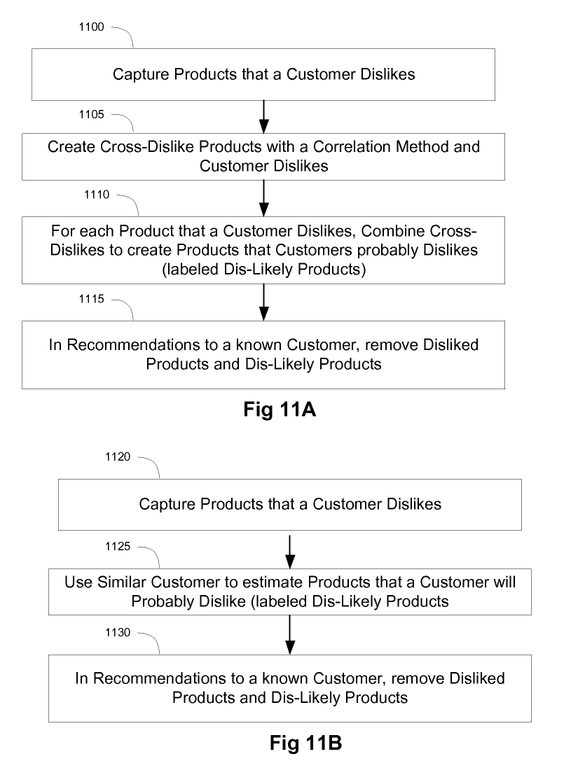

Shoppers like to control their recommendations, such as say they are not interested in a product. You see this for ads at Hulu.com where the user can say that they don't like an ad. Or at Pandora radio, Pandora.com, where a user can say they don't like a song. However, this just removes the ad or that song. Fully interactive recommendations learn from this dislikes, just as they learn from likes, views and purchases, as shown in FIG. 11A.

Disliked products for each customer are stored. Dislikes include any product that a user has shown they don't like. It includes recommended product rated with a dislike (i.e. thumbs down). For example, the user clicks on a ‘don't like’ icon on the recommendation. In addition, many retailer websites allow you to rate products, or give them a thumbs down. Any product with a thumbs down or low rating is included in the ‘don't like’ list. It can include returns, but that may just be a size or color issue, thus, returns are not preferably included in dislikes (unless it can be shown they didn't like the product or product family).

The system utilizes all user dislike data to learn “if you don't like this, you won't like these”. In other words, the same recommendation engine that is used to create cross-sell products based upon all purchases is used to create cross-dislike data and likelihood of dislike (labeled dis-likelihood) based upon all dislikes. Specifically, for the system described in patent application Ser. No. 12/764,091, section 3: Correlation Training for Non-Rated Data, an input of dislike product IDs and user IDs is used to create the cross-dislike. The genomic aspect is not used, since it is better to error on the side of caution for dislikes.

Based upon the cross-dislike products, and the products that a customer has already said they dislike, the system can find products that the customer probably dislikes. It combines the results as described patent application Ser. No. 12/764,091 in section ‘Likely Items and Likely Users’ on page 27. In summary, it combines all cross-dislikes for each disliked product for that customer, adds the dis-likelihood for common products, and orders by total dis-likelihood. It can use the normalization schemes discuss in the related patent app. The result is dis-likely items for customer, or for fun, you can call them personalized down-sell. If the customer has bought a dis-likely item, it is removed from the list. The preferred embodiment stores 20 dis-likely items for each customer.

In the preferred embodiment, the recommendation system stores all products that the user does not like. This list can be any length, and can be a different length for each customer (a.k.a. a jagged list). It can also be stored on the server or in a cookie on the customer's machine. A cookie reduces server cost, and must be read each time a customer browser the retailer's website. In addition, the recommendation system stores the dis-likely items for each customer. This list is 20 items per customer. Then, before any recommendation is shown to the customer, the products that the customer does not like or are listed in the dis-likely items are eliminated from the recommendations.

This solution enables ratings data to create very powerful recommendations using in a correlation-based recommendation engine for non-rate data. The complete solution uses items with positive ratings, along with sales data, to create cross-sell, and the items with negative (or low) ratings to create cross-dislike. The cross-dislike is used to create dis-likely items, which are used to personalize the recommendations for the customer.

In an alternative embodiment, the cross-dislike items and dis-likelihood are mathematically combined, such as subtracted from, the cross-sell items and likelihood to affect cross-sell, independent of a customer. These are used instead of, or with the dis-likely items for personalization of recommendations when the customer is known.

As shown in FIG. 11B, in another alternative embodiment, dis-likely products are found using similar customers. The similar customers are found because they have similar purchasing habits and/or have similar dislike habits. There are many known techniques based upon purchases to find similar customers, and the same techniques can be applied to dislikes. For example, customer pairs with many common dislikes are similar. Methods based upon purchases and dislikes can be used, and similar customers for both purchases and dislikes are boosted as more similar customers. The similarity between customers can be added. Whether the customer has more purchases or dislikes determines which method is stronger for the customer. If the customer has more purchases, methods using purchases are better or weighted more heavily in the combination. If the customer has more dislikes, methods using dislikes are better or weighted more heavily in the combination. Then, similar customers are used to create dis-likely items based upon items that one customer dislikes and the other customer has not indicated that they dislike.

### 16. Recommendations in Social Networks

Informed Recommendations from Social Networks

Users in social networks are: members of groups, write about favorite items, and usually have a profile with information like gender, location, income, marital status, education level, favorite movie, song, album, book etc. This information is useful to generate effective recommendations.

If the store has actions by user's that have entered links to their social profile, these actions can be used to relate to these profile elements, and effectively recommend products. For example, if an item is known to be bought by men in the Northwest with masters or higher education, then it can be recommended to someone with no purchase history but matches the profile. The method is similar to filtering categories, previously discussed in this application. Specifically, the user's profile elements are related to items from historical actions, such as using methods discussed in section 3. Then, the target user's profile is used to determine the element with the highest likelihoods to each profile element. The different profile categories can be averaged, or weighted. For example, the likelihood of the gender category is weighted by 0.6 and the likelihood of the location category is weighted by 0.4.

However, the retailer may not be able to link to the social profile. The retailer may have their own user profile, and some match social profile categories, but not others. In addition, it is unlikely to have enough actions to match a profile element, such as a favorite movie, to an item. In this case, the social profile can be used to create an intelligent taxonomy to recommend items. In this method, items are labeled with category elements, and social profile elements are linked to categories. In a simple example, a diamond is labeled expensive, and it is recommended to users with over $100K income. In a more complex example, a car is labeled for adventurous men with a good income, and it is recommended to men with over $100K income that have selected movies and hobbies known to be adventurous, and have entered the word car in their blog or on their social “wall”. The taxonomy provides these labels from using databases that have already created this information. For example, the Internet Movie Database (IMDB) can be used to convert favorite movies to genre of romantic, adventure, etc.

This manual creation of desirable profile elements for products can be enhanced or replaced by providing an automated solution. The method uses a standard taxonomy.

A simple generic example of a standard taxonomy is:
Category 1, weight 1—element 1.1, element 1.2, element 1.3
Category 2, weight 2—element 2.1, element 2.2
Category 3, weight 3—element 3.1, element 3.2, element 3.3, element 3.4, element 3.5

The method is to link retailer's user profile to the standard taxonomy, link a social networks profile to the standard taxonomy, use previous actions from the retailer to relate items to elements of the taxonomy with likelihood of action for the item and each taxonomy element, and finally recommend items based upon the user's social profile and these likelihoods.

A specific example of a standard taxonomy is shown below with five categories, and two to five elements in each category, along with a weight for each category.
Gender, 0.25—male, female, boy, girl
Age. 0.25—if age is included, gender is only male and female
Income/Price tier. 0.25—expensive, moderate, cheap
Personality, 0.15—adventure, home-body, traveler
Key words, 0.1—on “wall” or in blog or tweet

User profiles at the retailer are linked to each category element in the standard taxonomy. Then, training uses actions (i.e. sales) to generate a likelihood to relate each product to each category element in the standard taxonomy.

Next, social network profiles are linked to the standard taxonomy. Some links are direct, like gender and age. Others use secondary databases, like IMBD, to link favorite items to the standard taxonomy, such as book and movie genres to personality. Some use standard taxonomy prior art, such as linking text in posts to personality.

Finally, the system recommends the product with the highest likelihood using the previously determined likelihoods for each of the target user's standard profile element as determined from the social network.

For example, using the example standard taxonomy, if the target user is a male, age 20-30, $50K-$100K income, adventurous, who blogs about cars, boats and engines, product A has likelihoods of 0.3, 0.2, 0.3, 0.4, respectively and a keyword car, whereas product B has likelihoods of 0.4, 0.1, 0.2, 0.1, respectively, and keyword vacation—product A is recommended to the target user.

Automated Friend Recommendations from Social Networks

Friends love recommendations from other friends. A way to automate that is to let friends know what other friends bought on a retailer's website, or which friends bought a specific product. The prior art requires you to sign into Facebook—and then after some calculations, shows you what friends have bought. This is too slow and shoppers leave most web pages after 1.5 seconds.

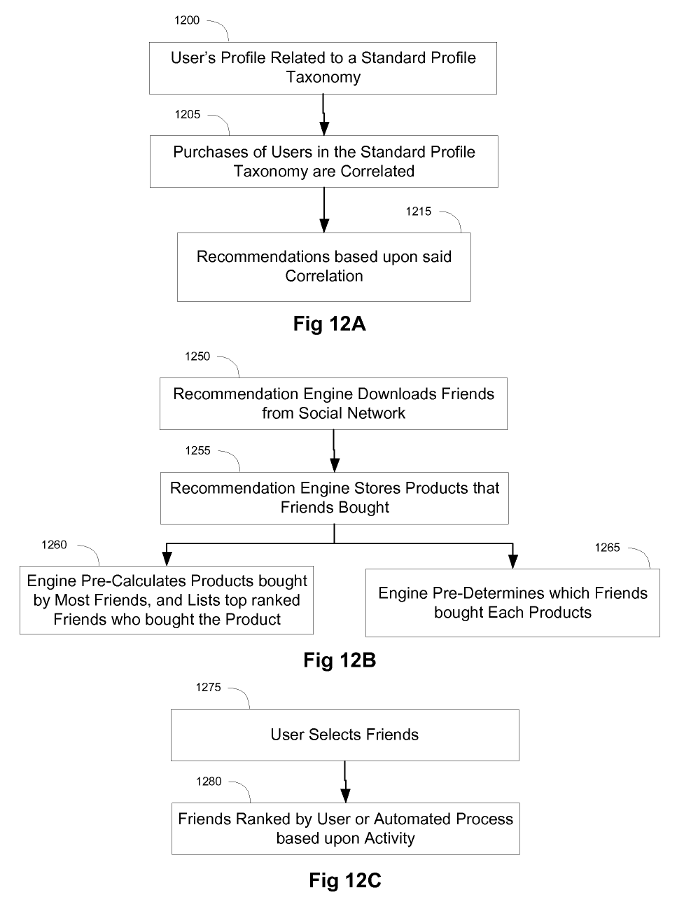

As shown in FIG. 12B, Our novel solution pre-calculates what friends have bought on a website and stores it in memory or a database on the server so it can be displayed immediately when a user browsers a retailer's website.

The recommendations generation process is as follows. First, the user's list of friends is obtained. This can be obtained because the user provided their social network logon information to the website, the user has clicked on a button linking the website to the user's social network (e.g. Like button), or the user's email is used to lookup the user in the social network (if the social network is open, like Twitter). Then, the user and their friends are linked to user IDs on the website, such as email addresses. For each product, the system looks at the retailer's sales data and stores the number of times that a friend bought the product. The top several items, like 20, that have the most action by friends are saved in the recommendation list. The top few friends, like 3 friends, can also be saved for each recommended item.

The recommendation display process is that the user ID is sent to the recommendation engine and it returns the recommendation list, and possibly the friends that acted upon each recommended item.

Obviously, the user/shopper needs to allow this action. It can use OpenGraph on Facebook, or any similar social network. The displayed friends can be ranked to determine which 3 to select.

### —Social Networks Rank Friends—

As people have their social network for a while, they add more friends. Over time, people's friends change. It is rude to explicitly remove friends where the friend is told they are being removed. As such, in our novel embodiment, social networks allow the user to rank friends, such best friends, close friends, acquaintances, and x-friends. The network can also automatically rank friends, such as by activities between friends. For example, friends in more similar groups, or that post to each other's page (i.e. “wall”) are ranked higher than friends that don't communicate. Finally, the retailer store can rank friends where friends that have bought more at that store are top ranked.

The data storage for this solution is reasonable. For each customer it lists top 20 products and 5 friends for each product. It can be saved in memory or easily cached, as described below.

Furthermore, the friends who bought each product can be shown. This requires storing all the friends, or the top five friends, who bought each product for each customer. This usually requires a database on the server to be responsive and effective. In a relational database that links customers to friends and friends to purchase, this can be done real-time with SQL. Alternatively, it can be pre-calculated for each customer and stored in a flat database, where for each customer, each product is saved with the friends who bought it. This is more efficient if the number of friends is limited and ranked (as discussed above). Thus, for 100K customers, 1K products and listing 5 friends, this requires 500 million entries, or around 2 GBs of storage for flat files.

### 17. Replacements File

For many retailers, product SKUs change, but the product is unchanged or very similar to a previous version. For example, the same pair of pants may have a new SKU each summer. Since recommendations system are based upon previous actions (i.e. sales or views, such as on a website) of the products, using the historical actions on previous products is useful. Specifically, creating a file that list an original product ID and then the new product ID such that the previous actions can be used in the calculation of recommendations is very useful. It's extremely useful for a midsize retailer where actions are less frequent, and it takes time to build up new actions.

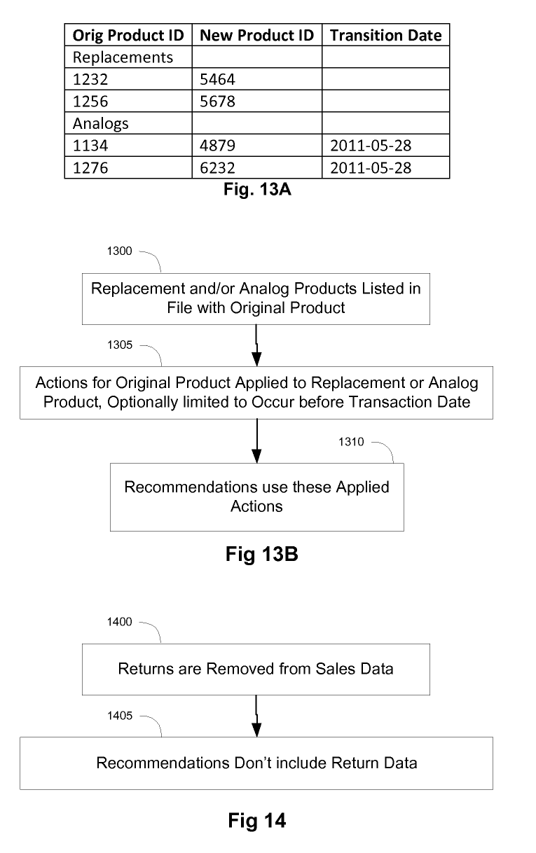

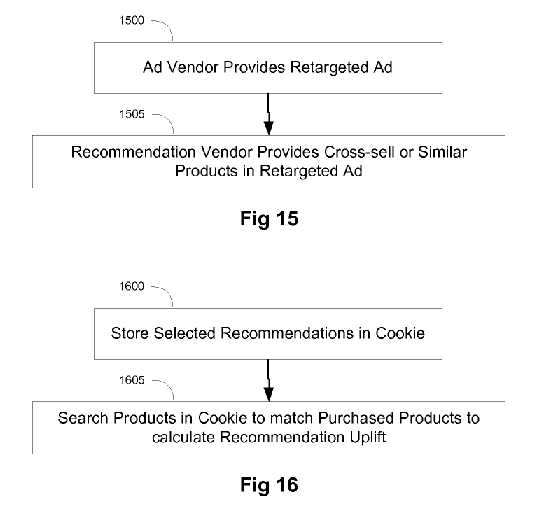

As shown in FIGS. 13A and B, a file with [Original Product ID]<tab>[New Product ID] on each line is created. Then, the action for each old product ID are applied to the new product ID.

Furthermore, the new product may be similar, and the old product may not be discontinued. However, the new product is so similar to an existing product that the action data is useful. The implementation is unchanged except the system cannot assume that the original product is discontinued. It must check the file catalog for the existence of the original product.

Alternatively, a separate section or file can be created for these analog products. As such, replacement products assume the old product does not exist, and the analog products assume the original product still exists.

For replacement products, the actions on the original product become less relevant over time since the original product is discontinued and has no new actions. In fact, for most systems, the historical sales only go back a specific amount of time, such as a year, so the original product will fade in that amount of time. For analog products, the retailer can be provided the option to decide if they want to continue to use actions on the original product to apply to the new product. If this option is included, a transition date needs to be included with the new product such that actions after that transition date on the original product do not apply to the new analog product. For this case, the alternative format, which includes different sections for replacement and analog products are preferable since it's easier to process.

Finally, it is preferable that parent products are used for product families for midsize retailers so that actions on the family are cumulative. For example, product families include size and color of a shirt, and a child product is of a specific size and color.

### 18. Remove Returns

On many ecommerce sites, such as for shoes, shoppers purchase several similar items and try them on and return the ones they don't like. They could be the wrong size or color. In this case, the purchase data creates an issue that items that are bought together, a.k.a. cross-sell, are actually similar items. This problem is alleviated by ignoring returns items.

For patent application Ser. No. 12/764,091 included by reference, the export of the sales data from the retailer ignores returned items such that the recommendations are not included in the calculation of recommendations. Alternatively, the returns are included in a separate export, such as a returns file, and sales for returns are removed inside the recommendation algorithm. In either case, the return includes a product ID and customer ID, and optionally a quantity and date. If quantity is not included, a return of the same item more than one time must be listed each time it was returned.

Alternatively, the returns could have an interface where returns are sent one at a time in real-time, or several in a package. This interface could use XML. Again, these returns are removed from the sales data and not included in the calculation of recommendations.

### 19. Onsite Search

When a user searches on a website, and then selects a result, the result is linked to the taxonomy of the search term(s), and the selection is accumulated for that taxonomy. Then, when any future search term with the same taxonomy is entered, the results are arranged by the number of clicks. Similarly, searches that lead to sales in a few clicks can be used, or combined with selections where a sale counts as several selections, like 5.

The taxonomy can simply be a group of equivalent terms, such as cost, costs, price. It is much more effective if it relates to the goal of the search terms. There is prior art on determining the goal of terms.

### 20. Remarketing/Retargeting Ads

Remarketing is the action of an ad following you around after you visited the website. For retailers, the ad may include a product that you looked at or added to your cart. Showing it to you again, may motivate you to buy it. However, you may have not bought the product since it was not the right item or you found it cheaper somewhere else. In these cases, it will increase sales to show one or more similar items or cross-sell items in the ad. Thus, if the shopper didn't like that product enough, they may like a similar product. If the shopper bought the product somewhere else, they may like a cross-sell product.

The ad vendor tracks the shopper and the product. The ad company then calls the recommendation service with the shopper ID and product ID, and requests a predetermined number of similar and/or cross-sell items. The recommendation service returns the requested number of product IDs for similar and/or cross-sell items, respectively. The ad vendor then displays the thumbnail image, description, price and ‘buy now’ button. The ad vendor may have access to the product catalog database and obtain these objects for the product ID and the catalog, or they can use our service that returns the product ID along with this additional information, such as in a JSON array.

### 21. Credit Card Amounts

Patent application Ser. No. 12/764,091 discusses how to predict item ratings given historical ratings of items by users. If the ratings number represents the amounts on a credit card, and items are represented by the store at which the consumer made the purchase, the resulting prediction is how much the shopper will spend at the store. This amount can be used to prepare marketing materials for the credit card company to send to the consumer in their monthly bill. Similarly, the amounts could be accumulated for 3 months or 6 months, such that the estimate will be for 3 or 6 months, respectively. The credit card company can charge the store for distributing the marketing materials.

For example, if a consumer is expected to spend $100 at the store in the next 3 months, the credit card company can send a promotion for $25 off if the consumer spends $150 at the store. Similarly, the credit card company can send a listing of new items for the top three stores at which the customer shops.

If the credit card company tracks product purchases, these promotions can be at the product level and use cross-sell recommendations, like in remarketing.

Alternatively, if the consumer spends an amount dramatically out of line with the estimate, it can trigger a fraud review of the purchase. If there are several purchases out of character based upon the estimate, it can trigger a deeper fraud review or credit card freeze.

### 22. Cookies for Recommendation Uplift

Cookies are stored on user's computers by web browsers for a specific website. They include information related to that user. They are only updated by the browser when on the specific website. Thus, they are useful to store specific user information, such as recommendation products that the user has clicked on. This reduces infrastructure costs since these items don't have to be stored on the server of the recommendation provider.

Furthermore, when the user buys something (i.e. checks out), programming code in the shopping cart can review all of the recently selected recommendations to see if any match the purchased item(s). If so, the system can store an accumulation of the number of times that a recommendation led to a sale and the total amount. Analytics programs, such as Google Analytics, can save these facts in a custom variable. Therefore, the analytics program can show the revenue generated by recommendations. The specific recommended products that were purchased can be saved in the cookie, or as a cumulative text list in analytics. The text is cumulative since analytics packages usually have limited numbers of custom variables.

### Concluding Remarks

The foregoing descriptions of the preferred embodiments of the invention have been presented to teach those skilled in the art how to best utilize the invention. To provide a comprehensive disclosure without unduly lengthening the specification, the applicants incorporate by reference the patents, patent applications and other documents referenced above. Many modifications and variations are possible in light of the above teachings, including incorporated-by-reference patents, patent applications and other documents. For example, methods to determine related items can be used to determine related users, and vice-versa.

What is claimed is:

1. A method providing automated business rules, comprising the steps of:
a. creating a rule, where, if the feature product has predefined product attribute elements, and the recommended product has predefined product attribute elements, the recommend product's position in the recommendation list is modified
b. generating recommendations for a feature product
c. modifying the recommendation list according to said rule
wherein at least one of the steps utilizes a computing device.

2. The method of claim 1 wherein the rule promotes recommended products to a higher position in the recommendation list.

3. The method of claim 1 wherein the rule removes recommended products from the recommendation list.

4. A method providing recommendations from driver and influencer products, comprising the steps of:
a. generating driver recommendations for a driver product
b. generating influencer recommendations for an influencer product
c. combining driver and influencer recommendations where influencer recommendations are ignored if not already a driver recommendation
wherein at least one of the steps utilizes a computing device.

5. The method of claim 4 wherein the combination includes summing likelihoods for recommendations common to said influencer product and said driver product.

6. A method of improving recommendations for new products, comprising the steps of:
a. relating a new product to an original product,
b. using the actions on the original product to calculate recommendations for the new product,
wherein at least one of the steps utilizes a computing device.

7. The method of claim 6 wherein the new products is an analog of the original product and does not replace it, and the actions on the original product are used for both the original and analog product to calculate recommendations.

8. The method of claim 7 wherein said actions include an action data, and said actions on the original product are used to calculate the recommendation for said analog product if said action date of the action is before a transaction date.
